(19) United States
(12) Patent Application Publication
(10) Pub. No.: US 2026/0134253 A1
(43) Pub. Date: May 14, 2026

(54) DEVICE AND METHOD WITH AUTONOMOUS DRIVING USING ARTIFICIAL INTELLIGENCE

(71) Applicant: Samsung Electronics Co., Ltd., Suwon-si (KR)

(72) Inventors: Jiaqian YU, Beijing (CN); Lu XU, Beijing (CN); Chao ZHANG, Beijing (CN); Yiwei CHEN, Beijing (CN); Jaewook YOO, Suwon-si (KR); Sung Hyun CHUNG, Suwon-si (KR); Weiming LI, Beijing (CN)

(73) Assignee: Samsung Electronics Co., Ltd., Suwon-si (KR)

(21) Appl. No.: 19/270,661

(22) Filed: Jul. 16, 2025

(30) Foreign Application Priority Data
Nov. 13, 2024 (CN) 202411620058.6
Mar. 17, 2025 (KR) 10-2025-0034219

(51) Int. Cl. G06N 3/045; B60W 50/00; B60W 60/00; G06F 40/284; G06F 40/40; G06N 3/09; G06V 10/82; G06V 20/56

(52) U.S. Cl. CPC G06N 3/045; B60W 50/0097; B60W 60/0027; G06N 3/09; G06V 20/56; B60W 2050/0028; B60W 2540/21; B60W 2556/35; G06F 40/284; G06F 40/40; G06V 10/82

(57) ABSTRACT

A processor-implemented method includes processing a plurality of first information related to autonomous driving based on an artificial intelligence (AI) model comprising a first AI network and a plurality of second AI networks associated with one or more driving skills, and determining execution task information for autonomous driving, based on an output corresponding to the plurality of first information, generated by one or more second AI networks of the plurality of second AI networks, wherein the processing includes determining the one or more second AI networks associated with each of the plurality of first information based on the first AI network, and processing the plurality of first information based on the one or more second AI networks.

### CROSS-REFERENCE TO RELATED APPLICATIONS

This application claims the benefit under 35 USC § 119 (a) of Chinese Patent Application No. 202411620058.6 filed on Nov. 13, 2024 in the China National Intellectual Property Administration, and Korean Patent Application No. 10-2025-0034219 filed on Mar. 17, 2025 in the Korean Intellectual Property Office, the entire disclosures of which are incorporated herein by reference for all purposes.

### BACKGROUND

### 1. Field

The following description relates to a device and method with autonomous driving using an artificial intelligence (AI) model.

### 2. Description of Related Art

Autonomous machine systems may handle complex tasks in various situations. Representative examples thereof include autonomous driving systems that can automatically drive to a designated target destination, or robotic systems that can handle complex tasks specified by users. On the one hand, such systems may effectively reduce investment in human resources, and on the other hand, autonomous driving and robots may offer more convenient services in consumers' daily lives.

For example, current developments in autonomous driving are aimed at achieving Level 4/Level 5 driving automation. Such systems may solve various driving scenarios without the need for a driver. Those scenarios include driving tasks in rare special scenarios, scenarios with greater driving challenges, and completely new scenarios that have never been experienced. Autonomous driving has clear requirements to achieve higher level of automation and to improve the efficiency of artificial intelligence (AI) models that perform autonomous driving tasks. For example, AI models for autonomous driving that are lightweight and can achieve improved real-time inference speed, energy efficiency, and low costs at the same time may have great significance in practical applications.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes processing a plurality of first information related to autonomous driving based on an artificial intelligence (AI) model comprising a first AI network and a plurality of second AI networks associated with one or more driving skills, and determining execution task information for autonomous driving, based on an output corresponding to the plurality of first information, generated by one or more second AI networks of the plurality of second AI networks, wherein the processing includes determining the one or more second AI networks associated with each of the plurality of first information based on the first AI network, and processing the plurality of first information based on the one or more second AI networks.

Each of the plurality of first information may correspond to a different modality, and the determining of the one or more second AI networks may include generating two or more sets of second information comprising information corresponding to different modalities, by performing multi-modal fusion for each of the plurality of first information, and routing each of the two or more sets of second information to one or more associated second AI networks based on the first AI network.

The AI model may include either one or both of one or more layers comprising the first AI network and the second AI networks, and two or more layers connected in series or in parallel.

The AI model may include any one or any combination of any two or more of a first layer configured to sense a driving scenario of the electronic device, a second layer configured to predict a next state of the electronic device or an object positioned in the vicinity of the electronic device, and a third layer configured to plan either one or both of a control operation corresponding to the electronic device and a movement path corresponding to the electronic device.

The method may include generating an output of each of the layers, and performing either one or both of storing the output in a memory and providing the output to a user of the electronic device.

The one or more layers further may include a third AI network, and the method may further include processing the plurality of first information based on the third AI network.

The third AI network may include a first partial network trained based on autonomous driving-related data and/or a second partial network trained based on predetermined sample data, and the processing of the plurality of first information based on the third AI network may include either one or both of processing the plurality of first information based on the first partial network, and processing the plurality of first information based on the second partial network.

The determining of the execution task information for autonomous driving may include one of determining the execution task information for autonomous driving based on an output generated by processing the first information at the one or more layers, and determining the execution task information for autonomous driving based on an output of a terminal layer based on the first information, the terminal layer corresponding to an output layer connected to the one or more layers in series.

The method may include training the second AI networks based on the first AI network that is pre-trained, wherein the training of the second AI networks may include routing training data associated with different driving skills, among different autonomous driving-related data corresponding to driving skills, to different second AI networks among the second AI networks, based on the first AI network.

The method may include training the third AI network based on the first AI network that is pre-trained, wherein the training of the third AI network may include training the first partial network by routing the autonomous driving-related data to the first partial network based on the first AI network, pre-training the second partial network based on predetermined sample data, and wherein the training of the first partial network may be based on fixed network parameters corresponding to the pre-trained second partial network.

The method may include, in response to performance of one of the plurality of second AI networks failing to meet predetermined performance requirements, updating parameters corresponding to the one second AI network by training the one second AI network based on data corresponding to a driving skill associated with the one second AI network, fixing network parameters corresponding to the plurality of second AI networks, and updating network parameters corresponding to the first AI network by training the first AI network based on autonomous driving-related data.

The plurality of first information may include collected image information, input information received from a user of the electronic device, and/or information about a state of the electronic device, and the execution task information for autonomous driving may include any one or any combination of any two or more of information for determining a travel trajectory of the electronic device, information for determining an execution operation of the electronic device, information for interpreting the travel trajectory and/or the execution operation of the electronic device, and information for answering a question from a user of the electronic device.

In one or more general aspects, a processor-implemented method includes generating two or more sets of second information corresponding to different modalities, by performing multi-modal fusion for each of a plurality of first information related to autonomous driving, determining, using a first artificial intelligence (AI) network, one or more second AI networks from among a plurality of second AI networks associated with one or more driving skills, based on the generated two or more sets of second information, and determining execution task information for autonomous driving by processing, using the determined one or more second AI networks, the two or more sets of second information.

In one or more general aspects, an electronic device includes one or more processors comprising processing circuitry, memory comprising one or more storage media storing instructions that, when executed individually or collectively by the one or more processors, cause the electronic device to process a plurality of first information related to autonomous driving based on an artificial intelligence (AI) model comprising a first AI network and a plurality of second AI networks associated with one or more driving skills, and determine execution task information for autonomous driving, based on an output corresponding to the plurality of first information, generated by one or more second AI networks of the plurality of second AI networks, wherein, for the processing, the execution of the instructions may cause the electronic device to determine the one or more second AI networks associated with each of the plurality of first information based on the first AI network, and process the plurality of first information based on the one or more second AI networks.

Each of the plurality of first information may correspond to a different modality, and for the determining of the one or more second AI networks, the execution of the instructions may cause the electronic device to generate two or more sets of second information comprising information corresponding to different modalities, by performing multi-modal fusion for each of the plurality of first information, and route each of the two or more sets of second information to one or more associated second AI networks based on the first AI network.

The AI model may include either one or both of one or more layers comprising the first AI network and the second AI networks, and two or more layers connected in series or in parallel.

The AI model may include any one or any combination of any two or more of a first layer configured to sense a driving scenario of the electronic device, a second layer configured to predict a next state of the electronic device or an object positioned in the vicinity of the electronic device, and a third layer configured to plan either one or both of a control operation corresponding to the electronic device and a movement path corresponding to the electronic device.

The execution of the instructions may cause the electronic device to generate an output of each of the layers, and perform either one or both of storing the output in a memory and providing the output to a user of the electronic device.

The one or more layers further may include a third AI network, and the execution of the instructions may cause the electronic device to process the plurality of first information based on the third AI network.

The third AI network may include a first partial network trained based on autonomous driving-related data and/or a second partial network trained based on predetermined sample data, and for the processing of the plurality of first information based on the third AI network, the execution of the instructions may cause the electronic device to perform either one or both of processing the plurality of first information based on the first partial network, and processing the plurality of first information based on the second partial network.

Other features and aspects will be apparent from the following detailed description, the drawings, and the claims.

### BRIEF DESCRIPTION OF THE DRAWINGS

FIG. 1 illustrates an example of a method executed by an electronic device according to one or more embodiments.

FIG. 2A illustrates an example of a framework of an artificial intelligence (AI) model executed by an electronic device according to one or more embodiments.

FIG. 2B illustrates an example of a framework of an AI model executed by an electronic device according to one or more embodiments.

FIG. 3 illustrates an example of a difference between an AI model according to a typical embodiment and an AI model according to one or more embodiments.

FIG. 4 illustrates an example of a difference between an AI model according to a typical embodiment and an AI model according to one or more embodiments, in a method of processing modalities.

FIG. 5A schematically illustrates an example of a structure of layers included in an AI model according to one or more embodiments.

FIG. 5B schematically illustrates an example of a structure of layers included in an AI model according to one or more embodiments.

FIGS. 6A to 6C illustrate an example of a method of training an AI model according to one or more embodiments.

FIG. 7 illustrates an example of a comparison of autonomous driving-related outputs between an AI model according to a typical embodiment and an AI model according to one or more embodiments.

FIG. 8 illustrates an example of a schematic structure of an electronic device according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the present disclosure. Terms, such as those defined in commonly used dictionaries, are to be interpreted as having a meaning that is consistent with their meaning in the context of the relevant art and specifically in the context of the present disclosure, and are not to be construed as an ideal or excessively formal meaning unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Hereinafter, examples will be described in detail with reference to the accompanying drawings. When describing the examples with reference to the accompanying drawings, like reference numerals refer to like components and a repeated description related thereto will be omitted.

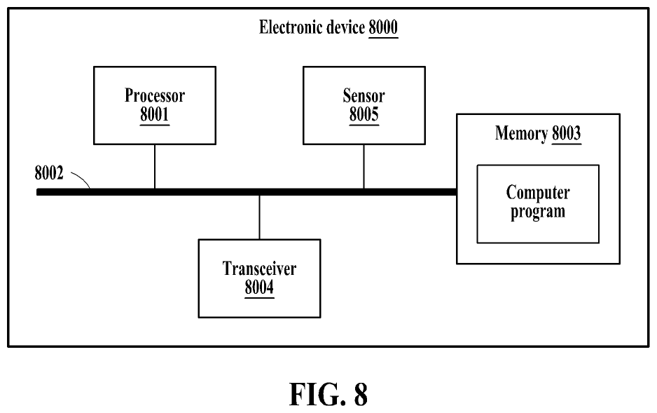

Hereinafter, an electronic device (e.g., an electronic device 8000 of FIG. 8) described through embodiments or at least some functions of the electronic device may implement an artificial intelligence (AI) model. For example, the electronic device or at least one of multiple modules of the electronic device may implement an AI model. The AI-related functions may be performed by non-volatile memory, volatile memory, and a processor (e.g., a processor 8001 of FIG. 8) of the electronic device.

The processor may include one or more processors. In this case, the one or more processors may be or include one or more general-purpose processors (e.g., a central processing unit (CPU), an application processor (AP), etc.) and/or one or more pure graphics processors (e.g., a graphics processing unit (GPU), a visual processing unit (VPU), etc.), and/or one or more AI-dedicated processors (e.g., a neural processing unit (NPU), an accelerator, etc.).

The one or more processors may control the processing of input data based on predetermined operating rules and/or AI models stored in the non-volatile memory and the volatile memory. The one or more processors may provide the predefined operating rules and/or AI models through training or learning.

Here, providing the predefined operating rules and/or AI models through learning may indicate that the one or more processors obtain the predefined operating rules and/or AI models with desired characteristics by applying a learning algorithm using a plurality of training data. The learning algorithm may be performed by the electronic device itself in which the AI models according to embodiments are executed, and/or may be implemented by a separate server/external device and/or a system.

For reference, the AI models may include a plurality of neural network layers. Each of the neural network layers may perform a neural network operation based on input data of the corresponding layer (e.g., the computation result of the previous layer and/or input data of the AI model) and a plurality of weight values included in the corresponding layer. By way of example, AI models may include, but are not limited to, convolutional neural networks (CNNs), deep neural networks (DNNs), recurrent neural networks (RNNs), restricted Boltzmann machines (RBMs), deep belief networks (DBNs), bidirectional recurrent deep neural networks (BRDNNs), generative adversarial networks (GANs), and deep Q-networks.

For reference, the learning algorithm may be a method of using a plurality of training data to train a predetermined target device (e.g., a robot) to induce, allow, and/or control the target device to determine to perform or predict a predetermined operation. By way of example, the learning algorithm may include, but is not limited to, supervised learning, unsupervised learning, semi-supervised learning, and/or reinforcement learning.

The methods described through the embodiments below may be associated with one or more technical fields such as speech, language, image, video, and/or data intelligence.

For example, the following methods performed by an electronic device according to one or more embodiments may relate to the field of speech or language. For example, an electronic device for performing a method of user speech recognition and user intent interpretation may receive a speech signal as an analog signal through a speech signal acquisition device (e.g., a microphone), and convert a speech segment into computer-readable text using an automatic speech recognition (ASR) model. The electronic device may acquire the utterance intent of the user by interpreting the converted text using a natural language understanding (NLU) model. For reference, the ASR model or the NLU model may be an AI model. The AI model may be processed by a dedicated processor configured with a predetermined hardware architecture to perform an operation corresponding to the AI model. The electronic device may obtain an AI model through training. Here, the term “obtaining an AI model through training” may refer to obtaining a predefined operation rule or AI model having desired features (or objectives), based on training a basic AI model with multiple training data using a training algorithm. Language understanding is a technology used to recognize and apply/process human language/text, including natural language processing, machine translation, dialogue systems, question answering, and/or speech recognition/synthesis.

For example, the following methods performed by an electronic device according to one or more embodiments may relate to the field of image or video. For example, among the methods performed by the electronic device, an object identification method may be a method of identifying an image or a feature of an image using image data as input data for an AI model and obtaining corresponding output data. The electronic device may obtain an AI model for object identification by training the AI model. For example, the electronic device may relate to the field of visual understanding of AI technology for recognizing and processing objects similarly to human vision. For example, the electronic device may perform object recognition, object tracking, image search, person recognition, scene recognition, three-dimensional (3D) reconstruction/positioning, and/or image enhancement.

For example, the electronic device may be related to the field of data intelligence processing. For example, an autonomous driving method performed by the electronic device may include a method for vehicle operation and environment recognition, prediction, and vehicle operation planning. For example, the electronic device may recognize a scene, predict a next state, and plan a driving operation and/or driving trajectory based on driving-related information using an AI model. A processor of the electronic device may perform a pre-processing task on data and convert the pre-processed data into a form suitable for use as input of the AI model.

For example, the electronic device may be associated with autonomous driving scenarios. For example, the electronic device may be utilized in scenarios such as autonomous driving, tower crane hydraulic climbing formwork construction, and/or various robot controls. Hereinafter, examples of the autonomous driving scenarios performed by the electronic device will be described in detail.

The electronic device according to one or more embodiments may perform a knowledge-based autonomous driving operation through an AI model (e.g., a skill-based mixture of skill experts (MoSE)). For reference, when a human learns driving skills, they may learn different driving skills according to different driving scenarios. Furthermore, in a predetermined driving scenario, a human may go through multiple steps of cognitive processes such as observation, recognition, prediction, and final decision-making when making a corresponding driving decision. For example, a human may utilize various driving skills in a predetermined driving scenario. Such a stepwise approach of humans in a predetermined driving scenario may also be utilized for various autonomous driving models. Therefore, the electronic device according to one or more embodiments may perform autonomous driving through an MoSE by mimicking the human learning and inference processes.

The electronic device according to one or more embodiments may further enhance the performance of a lightweight multi-modal vision language model (VLM) for processing a predetermined task based on a mixture of experts (MoE) technique. Thus, the electronic device of one or more embodiments may perform an effective data and computation framework for autonomous driving tasks. The technology implemented by the electronic device may be referred to as MoSE, although the term is not limited thereto. As inspired by the human learning strategy, the electronic device according to one or more embodiments may train networks included in the AI model by skill through a router in a multi-modal scenario. For example, the electronic device may learn a method of identifying basic driving skills in different driving scenarios (e.g., waiting at an intersection signal, highway lane merging, traffic congestion section, nighttime driving, and driving in rain) through the router. In addition, the electronic device may induce the development of driving skills for a target scenario by allowing each layer included in the AI model to focus on various driving scenarios through the router. For reference, the router may be referred to as a routing network or a first AI network. An example of the operation of the first AI network will be described in detail below. Furthermore, the electronic device may learn driving skills by item at different layers. The electronic device may train layers corresponding to different experts through a hierarchical training strategy, to enforce the multi-modal VLM to autonomously perform stepwise inference. The electronic device according to one or more embodiments may show better consistency in problem-solving for autonomous driving through different layers. In addition, the electronic device may train the layers corresponding to different driving experts included in the AI model hierarchically and step-by-step, thereby performing valuable driving assistance tasks (e.g., signal detection, obstacle recognition, lane change decision, etc.) only through a single forward process, without introducing additional context or multiple rounds of question and answer (QA). Thus, the electronic device of one or more embodiments may stably perform downstream tasks for autonomous driving even with limited computing resources.

The electronic device according to one or more embodiments may operate a new structure (e.g., MoSE) of AI model to enable a small-scale large language model (LLM) to exhibit better inference capability in a predetermined task (e.g., autonomous driving). In addition, the electronic device may train the AI model. Furthermore, the electronic device may reduce the GPU occupancy time of the MoSE-structured AI model through a scenario-level skill-step training strategy and a case-level skill-step planning strategy, and ensure that the AI model may exhibit reasonable performance even when training data and model size are limited. Finally, through experiments using the DriveLM dataset (a driving-related dataset), the electronic device may verify that the MoSE-structured AI model may achieve performance equivalent to or better than that of a larger-scale LLM while processing multi-view inputs.

Hereinafter, an example of a method executed by an electronic device according to one or more embodiments is described in detail.

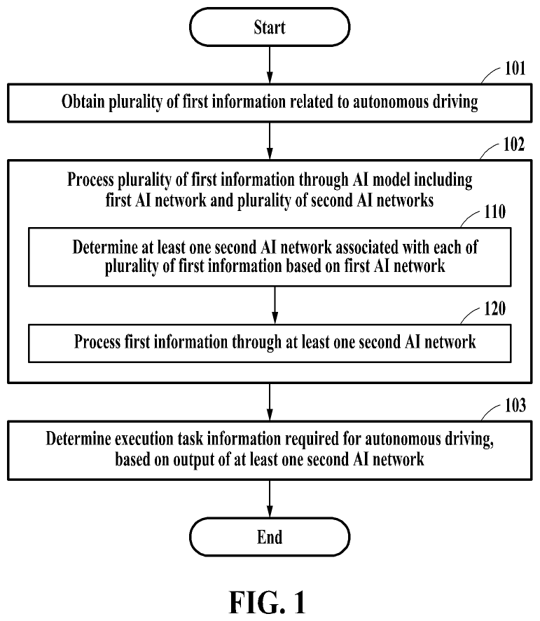

As shown in FIG. 1, the electronic device according to one or more embodiments may perform operations 101 to 103. Operations 101, 102, 110, 120, and 103 of FIG. 1 may be performed in the sequence and manner as illustrated in FIG. 1. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 101, the electronic device according to one or more embodiments may obtain a plurality of first information related to autonomous driving. For example, the electronic device according one or more embodiments may obtain the plurality of first information related to autonomous driving during an autonomous driving process. The plurality of first information related to autonomous driving may include, for example, red, green, and blue (RGB) images of the surrounding environment captured by sensors (e.g., camera, light detection and ranging (LIDAR), etc.) attached to or included in the electronic device (e.g., the sensor 8005 of FIG. 8), collected road environment information (e.g., vehicle, pedestrians, obstacle detection data), system information (e.g., vehicle state information such as speed, acceleration, steering angle, fuel or battery status), global positioning system (GPS) and map data (e.g., current location, destination, road network information), traffic signal and road sign information (e.g., traffic light color, speed limit, stop line position), driver inputs (e.g., voice instructions, touchscreen manipulations, button inputs), and internal/external environment data of the vehicle (e.g., weather, brightness, and road conditions). The electronic device may obtain the first information directly (e.g., generate the first information) and/or receive the first information from an external device.

In operation 102, the electronic device may process the plurality of first information through an AI model. In this case, the AI model may include a first AI network and a plurality of second AI networks. Each of the second AI networks may be associated with at least one driving skill. The first network may serve to analyze first information being input to determine a driving scenario corresponding to the information, and route the information to an appropriate second AI network. The second AI networks may be expert networks to perform predetermined driving skills, and each second AI network may be associated with one or more predetermined driving skills such as changing lanes, following vehicles, responding to signals, controlling the speed, and the like. For example, the electronic device may analyze the plurality of first information input into the AI model to determine a corresponding driving scenario (e.g., driving in the rain, driving on the highway, etc.), and transmit the determined driving scenario to a second AI network, which is an expert network to output optimal driving skills.

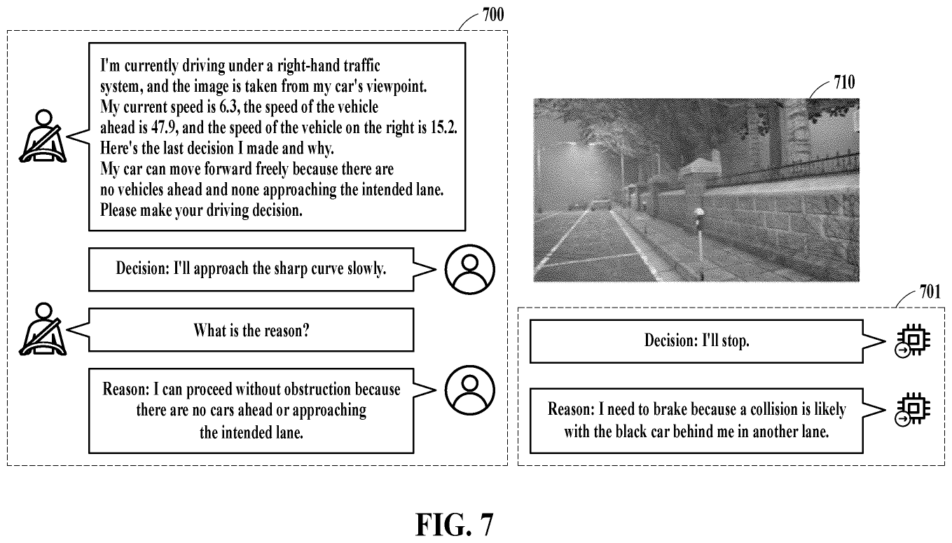

In operation 103, the electronic device according to one or more embodiments may determine execution task information to be used for autonomous driving, based on an output corresponding to the plurality of first information, generated by at least one second AI network. For example, in the case of changing lanes, the electronic device may generate a probability-based feature indicating whether to change lanes as an intermediate output corresponding to the plurality of first information by the second AI network. The electronic device may determine execution task information to be performed finally based on the intermediate output generated by the second AI network. For example, the electronic device may determine execution ask information including an expected driving trajectory of a vehicle, a planned driving operation (e.g., acceleration or deceleration), an interpretation corresponding to an execution task (provided to support a task object to understand a current driving task), and a response to answer a question from a user of the electronic device. For reference, execution task information to be used for autonomous driving may include information for determining a driving trajectory. For example, the information may include first information for determining a driving trajectory including coordinate information, map information, and road condition information, second information for determining an execution operation including information that the vehicle plans to change lanes 50 meters ahead, and/or increases the driving speed to 100 kilometers per hour (km/h), third information for interpreting a driving trajectory and/or an execution operation that provides the reason for lane changing such as “the left lane ahead is narrowed) with respect to a lane changing task, and forth information for answering a question of the task object. However, the execution task information is not limited to those examples, and an example of the information for answering a question of the task object will be described in detail below with reference to FIG. 7. In an example, operation 103 may further include performing autonomous driving of the vehicle based on the determined execution task information. The performing of the autonomous driving may include controlling the vehicle to change lanes, to drive along the expected driving trajectory, to perform the planned driving operation, and/or to display content related to the execution task a display screen, as non-limiting examples.

Operation 102 of processing the plurality of first information through an AI model by the electronic device according to one or more embodiments may include operations 110 and 120.

In operation 110, the electronic device according to one or more embodiments may determine at least one second AI network associated with each of the plurality of first information based on the first AI network.

In operation 120, the electronic device according to one or more embodiments may process the first information based on the at least one second AI network.

For example, the electronic device may obtain a plurality of information (e.g., first information) related to autonomous driving as input of the AI model, and output information about a task to be executed during autonomous driving.

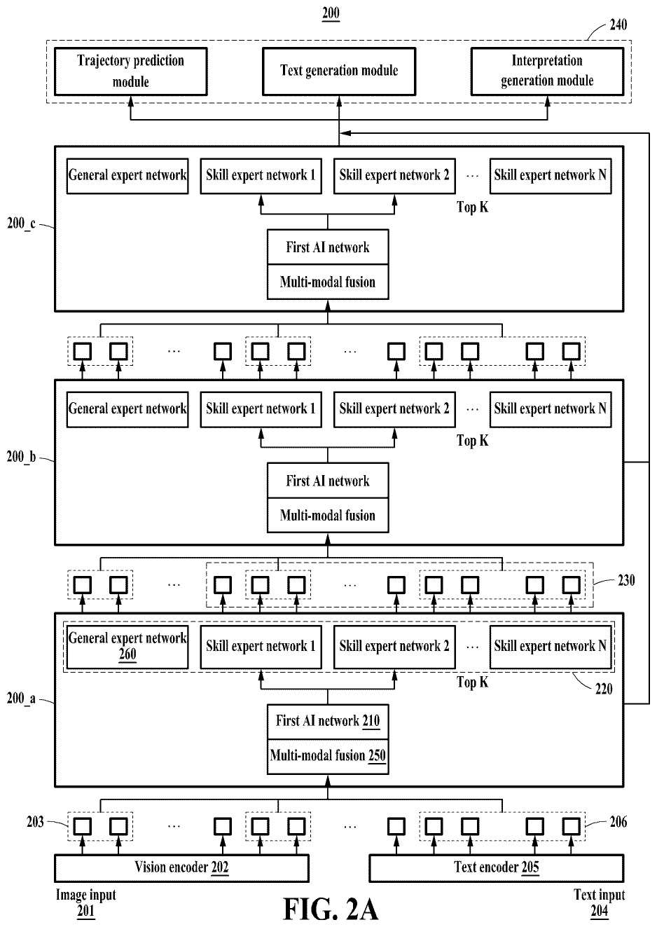

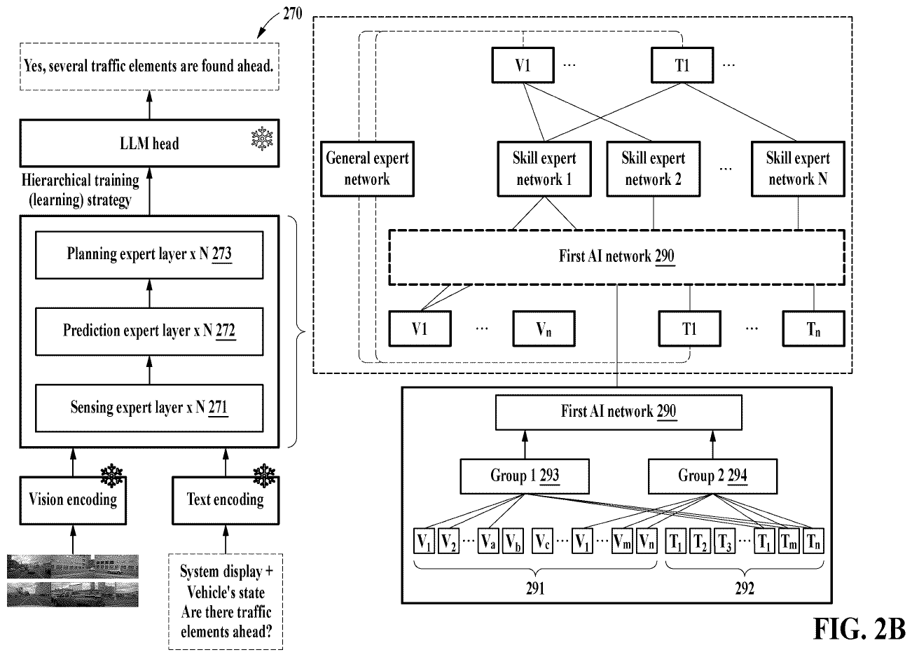

FIG. 2A illustrates an example of a framework of an AI model executed by an electronic device according to one or more embodiments.

Referring to FIG. 2A, an electronic device may perform autonomous driving based on an AI model 200. The AI model 200 may be referred to as an MoSE. For example, the AI model 200 may include a plurality of layers. For example, the AI model 200 may include a first layer 200_a, a second layer 200_b, and a third layer 200_c. Each of the layers may be associated with a driving skill to be used for the electronic device to perform autonomous driving. For example, the first layer 200_a may be a sensing expert layer. For example, the sensing expert layer may be a layer for sensing a driving scenario of the electronic device. For reference, driving scenarios may be various road environments and traffic situations that the electronic device may face during driving. For example, recognizing the traffic light color and whether a pedestrian is crossing as the electronic device approaches an intersection may be one driving scenario, but embodiments are not limited thereto. For example, the sensing expert layer may recognize and analyze the road environment around a vehicle. For example, the sensing expert layer may include functions that process information obtained through sensors (e.g., the sensor 8005 of FIG. 8) such as a camera, LiDAR, and a radar to detect objects such as pedestrians, vehicles, traffic lights, road signs, and to analyze road conditions. The second layer 200_b may be a prediction expert layer and may predict the movements of nearby vehicles and pedestrians based on data collected from the sensing expert layer and analyze expected state changes of the vehicle. For example, the prediction expert layer may include functions that evaluate the risk of collision by considering vehicle spacing, speed, and traffic flow, and determine whether lane changing is possible (e.g., whether lane changing may be performed safely (e.g., without collision)) or whether the vehicle ahead is decelerating. The third layer 200_c may be a planning expert layer that may determine a driving route and an execution operation of the vehicle based on the information generated in the sensing and prediction steps. For example, the planning expert layer may optimize execution tasks such as acceleration, deceleration, lane changing, and responding to traffic signals of the vehicle, to derive the safest and most efficient driving strategy under given traffic conditions. However, the names and characteristics of the layers are not limited thereto.

The plurality of layers (e.g., the first to third layers 200_a to 200_c) may each include a first AI network 210 (e.g., also referred to as a routing network), a plurality of second AI networks 220 (e.g., skill expert networks 1 to N, where N is an integer greater than or equal to “2”), a multi-modal fusion module 250, and a general expert network 260 (e.g., a third AI network).

The first AI network 210 may transmit input data to at least one corresponding second AI network of the second AI networks 220. The at least one second AI network may generate an output related to a specialized driving skill based on the received input data.

The electronic device according to one or more embodiments may obtain a plurality of input tokens by processing the obtained information (e.g., first information) through an encoder. By way of example, as shown in FIG. 2A, the electronic device may obtain a plurality of vision tokens 203 by processing an image input 201 through a vision encoder 202. In addition, the electronic device may obtain a plurality of text tokens 206 by processing a text input 204 through a text encoder 205.

The electronic device according to one or more embodiments may perform a task of determining an associated second AI network for each first information, based on the first AI network 210 (e.g., also referred to as the routing network or router). The electronic device may determine selection probabilities or weights for the second AI networks 220 (e.g., also referred to as the skill expert networks), in response to respective features of the input tokens, through the first AI network 210. The electronic device may select an appropriate skill expert network or a skill expert network group (e.g., including at least two skill expert networks) for each input token based on the determined selection probabilities or weights. For example, for each input token, the electronic device may select any one or more or all of skill expert networks having determined selection probabilities or weights greater than or equal to a predetermined threshold value. The electronic device may transmit the input data (e.g., input tokens) to the selected second AI networks 220, thereby extracting an output corresponding to the input data from each of the second AI networks 220. For example, the electronic device may select the skill expert network 1 and the skill expert network 2 corresponding to predetermined first information through the first AI network 210 such that the skill expert network 1 and the skill expert network 2 may process the first information simultaneously.

For reference, in various scenarios in which the electronic device performs autonomous driving, driving skills may overlap. For example, for the autonomous driving, the electronic device may perform vehicle following (i.e., car following) and speed control at the same time. Accordingly, the electronic device may implement one or more driving skills when processing the first information through one skill expert network. By way of example, as shown in FIG. 2A, the skill expert network 1 in the first layer 200_a(e.g., the sensing expert layer) may implement driving skills such as vehicle following and speed control by processing information (e.g., input tokens).

The electronic device according to one or more embodiments may determine a corresponding autonomous driving scenario by obtaining first information related to autonomous driving, and different autonomous driving scenarios may correspond to different driving skills. Hereinafter, examples of the autonomous driving scenarios are described with reference to Table 1 below, for example.

TABLE 1

| AUTONOMOUS | |
|---|---|
| DRIVING SCENARIOS: | DRIVING SKILLS: |
| Entering congested section | Vehicle following, Lane changing |
| Entering green wave (e.g., | flat road driving, Responding to |
| sequential green lights) section | traffic signals |
| Night driving | Adaptive high/low beam control |
| Driving in rain | Adaptive wiper control |

Table 1 only describes some autonomous driving scenarios and driving skills as examples, and more autonomous driving scenarios and driving skills may be associated in the field of autonomous driving. Accordingly, autonomous driving scenarios and the corresponding driving skills are not limited to those shown in Table 1 above. Referring to Table 1, the electronic device may use one or more skill expert networks (e.g., the second AI networks 220) to obtain a driving skill corresponding to an autonomous driving scenario, based on information corresponding to the same autonomous driving scenario. Accordingly, the electronic device may select one, two, and/or more second AI networks 220 based on the first AI network 210 (e.g., the routing network), corresponding to the information determined to be the same autonomous driving scenario. By way of example, the electronic device may activate the skill expert network 1 to process information 1 corresponding to a predetermined driving skill based on the first AI network. For example, the electronic device may generate an output corresponding to the predetermined driving skill by inputting the information 1 into the skill expert network 1.

The electronic device according to one or more embodiments may determine execution task information to be used for autonomous driving by integrating outputs 230 of the second AI networks 220. For example, the execution task information to be used for autonomous driving may include one or more of a predicted trajectory of movement of the electronic device, a generated text, and a generated interpretation. For example, the outputs generated by the first layer 200_a(e.g., the sensing expert layer), the second layer 200_b (e.g., the prediction expert layer), and the third layer 200_c (e.g., the planning expert layer) may be used as input of at least one module 240 for one of trajectory prediction, text generation, and interpretation generation. For example, the trajectory prediction module may generate a driving trajectory for autonomous driving. The text generation module may generate text information to be displayed (e.g., display the content related to the execution task in an autonomous driving scenario on a display screen of the vehicle to allow a user of the electronic device to check the content). The interpretation generation module may generate interpretation information about an execution task (e.g., generate a reason for performing a lane change task in response to the execution task in the autonomous driving scenario being changing lanes).

For reference, driving skills in autonomous driving scenarios may include one of flat road driving, responding to traffic signals, and vehicle following, as non-limiting examples. For example, to deal with various autonomous driving scenarios, driving skills may be updated according to actual requirements. For example, the electronic device may add a new second AI network to at least one layer of the plurality of layers (e.g., the first to third layers 200_a to 200_c). For example, the added second AI network may include an expert network to process information obtained while driving on an uneven road section, thereby implementing a driving skill suitable for the road situation.

The electronic device according to one or more embodiments may introduce the second AI networks 220 to the AI model 200 and process information related to driving skills to be used for different autonomous driving scenarios, thereby implementing specialized driving skills. Thus, the electronic device of one or more embodiments may effectively control the complexity of the AI model 200, such as the accuracy of sensing, prediction, and planning results of the AI model 200, while improving the performance of autonomous driving through the AI model 200.

According to one or more embodiments, each of the plurality of first information may include information about a different modality. For example, the plurality of first information may include image data (e.g., a vision modality) collected through a camera, speed and acceleration data (e.g., a numerical modality) collected from a sensor (e.g., the sensor 8005 of FIG. 8) of the vehicle, a voice instruction (e.g., a voice modality) from a driver, and road information (e.g., a text modality) provided by a navigation system. Accordingly, in operation 110 of determining at least one associated second AI network (e.g., one of the second AI networks 220) for each of the first information through the first AI network 210, the electronic device may perform operations as follows.

As the first operation, the electronic device according to one or more embodiments may obtain second information including information corresponding to at least two sets of different modalities by performing multi-modal fusion for each of the plurality of first information. Each set of second information may include information about a different modality.

As the second operation, the electronic device according to one or more embodiments may route each of the at least two sets of second information to at least one associated second AI network (e.g., one of the second AI networks 220) based on the first AI network 210.

The electronic device according to one or more embodiments may use the obtained first information as input of the AI model 220, and process various types of information in an autonomous driving scenario. For example, the electronic device may use, as input of the AI model 200, the first information including image information (e.g., images of the environment around the vehicle) collected from the camera module, information (e.g., driving instructions) input by a task object (e.g., a driver, a passenger, and/or a user) through voice, text, and/or touch manipulation, and information related to the state of the vehicle (e.g., driving speed, drivable distance, and tire pressure data). Further, the electronic device may use the acquired image information as the image input 201, and use the input information of the task object and the information related to the state of the vehicle as the text input 204. In this case, the electronic device may use first information including two modal information: image and text.

For the AI model 200 to better mimic the human learning process, the electronic device according to one or more embodiments may perform a multi-modal routing method for driving scenarios. For example, the electronic device may package the tokens 203 and 206 corresponding to different modalities (e.g., vision and text) in a multi-model manner (e.g., fuse first information having different modalities through the multi-modal fusion module 250 of FIG. 2A). Thus, the electronic device of one or more embodiments may better fuse information of driving scenarios and the routing network (e.g., the first AI network 210) to select a predetermined skill expert network (e.g., one of the second AI networks 220) according to a driving scenario.

By way of example, as shown in FIG. 2A, the electronic device may obtain the plurality of vision tokens 203 (e.g., the basic elements of the image) by processing the image input 201 through the vision encoder. Likewise, the electronic device may obtain the plurality of language tokens 206 (e.g., the smallest unit for text processing) by processing the text input 204 through the text encoder.

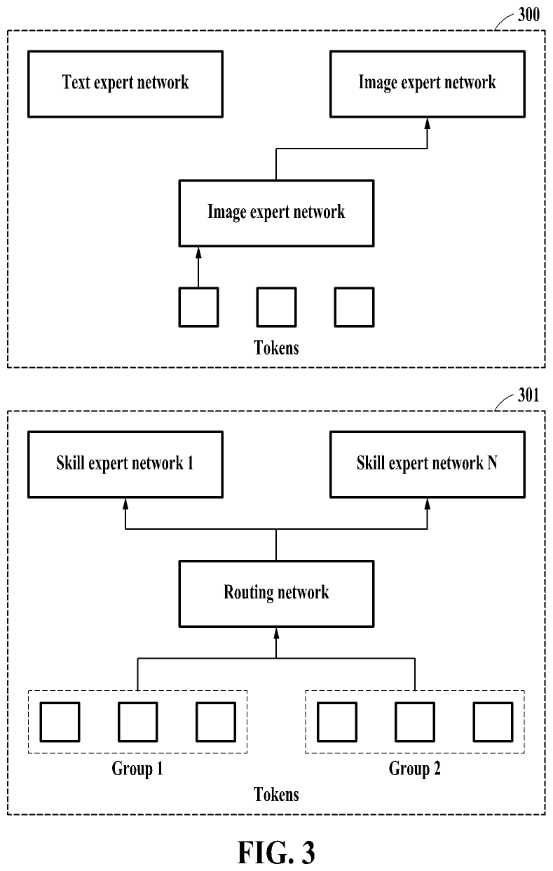

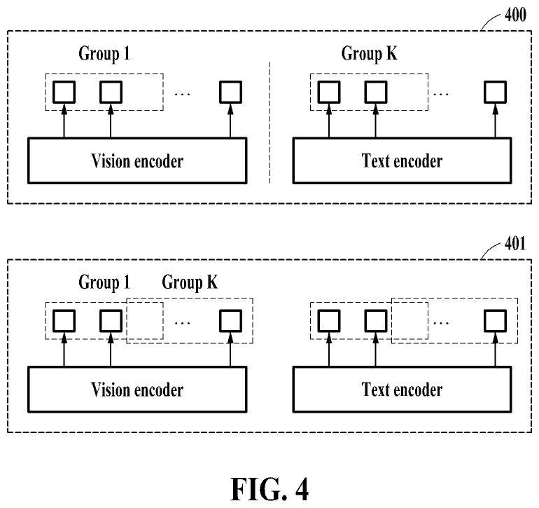

Referring to FIG. 4, a typical embodiment 400 may process the tokens obtained through the vision encoder and the tokens obtained through the text encoder separately. In contrast, an electronic device 401 according to one or more embodiments may package tokens with different modalities and provide richer scenario information to a first AI network (e.g., the first AI network 210 of FIG. 2A). For example, the electronic device 401 may package tokens corresponding to different modalities. For example, the electronic device 401 may package a first token, among the tokens obtained through the vision encoder (hereinafter, the vision tokens), and the tokens obtained through the text encoder (hereinafter, the text tokens) into a group 1. Further, the electronic device 401 may package a second token, among the vision tokens, and the text tokens into a group 2. The electronic device 401 may package a K-th token, among the vision tokens, and the text tokens into a group K. In this case, K may be a natural number greater than or equal to “2”. The electronic device 401 may package tokens with different modalities, thereby obtaining at least two groups of second information (e.g., tokens belonging to one group, obtained by packaging, being regarded as one group of second information). Referring to FIG. 3, a typical embodiment 300 (e.g., the typical embodiment 400 of FIG. 4) may transmit the vision tokens only to an image expert network through the routing network, and transmit the text tokens only to a text expert network through the routing network. In contrast, an electronic device 301 according to one or more embodiments (e.g., the electronic device 401 of FIG. 4) may process tokens groups (e.g., the group 1 and the group 2) corresponding to different modalities in a single processing process. For example, the electronic device 301 may transmit second information corresponding to the group 1 (e.g., including a portion of the tokens obtained through the vision encoder and a portion of the tokens obtained through the text encoder) to a skill expert network 1 (e.g., one of the second AI networks 220 of FIG. 2A) through the routing network (e.g., the first AI network 210 of FIG. 2A).

The method of packaging the tokens by the electronic device 301 or 401, described above with reference to FIGS. 3 and 4, is merely an example, and embodiments are not limited thereto. For example, the electronic device 301 or 401 may package tokens obtained based on high-resolution images and tokens obtained based on low-resolution images separately, using different rules.

For example, the electronic device may package tokens with different modalities based on multi-modal fusion processing on the plurality of first information. The electronic device may package the plurality of tokens into a plurality of token groups, thereby reducing the number of inputs to the routing network (e.g., the first AI network 210 of FIG. 2A). Thus, the electronic device of one or more embodiments may reduce the burden on the routing network, lower the computational complexity, retain the core information, and reduce redundancy, such that the AI model (e.g., the AI model 200 of FIG. 2A) may better understand and more accurately process the input data. For example, the electronic device may obtain a cross-modal token representation by combining the vision tokens and the text tokens through predetermined fusion strategies (e.g., attention mechanism, bilinear pooling, and the like).

LLMs and VLMs pre-trained based on network-level data have been applied to the field of autonomous driving. To perform a predetermined task (e.g., autonomous driving), the electronic device has applied relevant AI models to some end-to-end systems. The electronic device of one or more embodiments may achieve better generalization through knowledge-driven models, overcoming the limitations of existing data-driven models. Based on the AI models, the electronic device of one or more embodiments may achieve better performance in some long-tail problem scenarios and extreme situations, and provide the potential to reach full automation in autonomous driving systems.

The electronic device may configure a layer strategy of an LLM to perform an autonomous driving task, and consider several auxiliary tasks related to driving. For example, the electronic device may understand the current driving environment through the sensing expert layer (i.e., sensing), predict the subsequent states of the vehicle and nearby agents using the prediction expert layer (i.e., prediction), and plan the expected driving operation and driving trajectory based on the planning expert layer (i.e., planning). For example, the electronic device may configure an AI model by directly incorporating core tasks for autonomous driving (sensing, prediction, and planning) within the architecture of the LLM (e.g. layers).

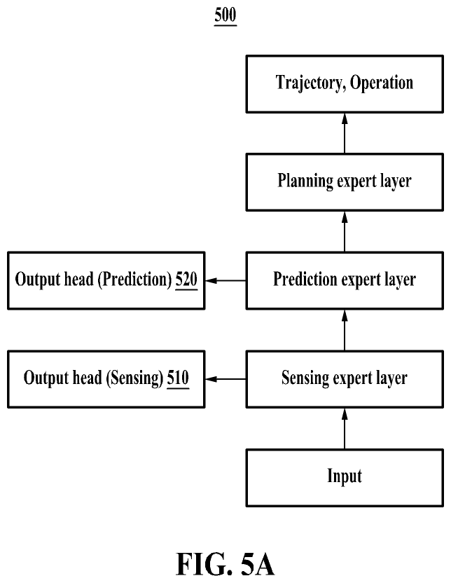

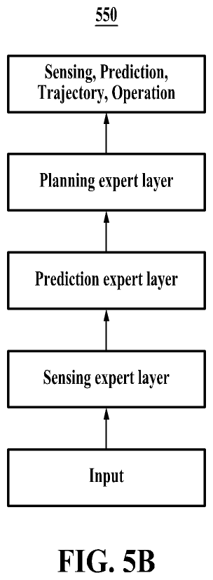

The electronic device of one or more embodiments may improve the performance of autonomous driving by utilizing multi-turn dialogues while performing a driving task based on an LLM or a vision-language model. Further, through the framework of an AI model (e.g., the AI model 200 of FIG. 2A) implemented by the electronic device, the electronic device of one or more embodiments may improve the performance of autonomous driving even with limited contextual understanding by using a lightweight models. To correct issues such as increased inference time and cost and the need for higher contextual understanding capabilities when performing autonomous driving using lightweight AI models corresponding to LLMs and VLMs, and to optimize the layer structure, the electronic device of one or more embodiments may use the two processing methods as shown in FIGS. 5A and 5B below.

FIGS. 5A and 5B schematically illustrate the structures of layers included in AI models.

Referring to FIG. 5A, an AI model 500 (e.g., the AI model 200 of FIG. 2A) may include a plurality of layers. For example, the AI model 500 may introduce additional output heads 510 and 520 to some layers (e.g., a sensing expert layer and a prediction expert layer) to extract intermediate results from respective different layers.

In contrast, referring to FIG. 5B, an AI model 550 may not introduce additional output heads (e.g., the output heads 510 and 520 of FIG. 5A), and an electronic device may implement the AI model 550 based on new training strategies. Both of the new training strategies for the new structure of the AI model 500 of FIG. 5A and the existing structure of the AI model 550 may neither require the electronic device to perform additional computation in the AI model-based inference process nor impede the real-time performance of algorithms.

According to one or more embodiments, an AI model (e.g., the AI model 200 of FIG. 2A, the AI model 500 of FIG. 5A, and/or the AI model 550 of FIG. 5B) may include one or more layers, and the layers may be connected to each other. For example, when the AI model includes at least two layers, the layers may be connected in series and/or in parallel. For example, as shown in FIGS. 5A and 5B, the layers (e.g., the sensing expert layer, the prediction expert layer, and the planning expert layer) may be connected in series. As another example, the layers may be connected in parallel, and each of the layers may be directly connected to an input interface and an output interface. As still another example, there may be an additional series connection relationship between layers connected in parallel. For example, even when layers 1, 2, and 3 are connected in parallel, the input of the layer 2 may include the input of the layer 1 and the output of the layer 1, and the input of the layer 3 may include the input of the layer 1 and the output of the layer 2.

For example, information not obtained by the AI model (e.g., the AI model 500 or the AI model 550) may be used as input of the first layer (e.g., the sensing expert layers of FIGS. 5A and 5B) connected in series and/or the layers connected in parallel. For example, in the AI model 500 shown in FIG. 5A, sensing information may correspond to the output result (e.g., a feature or an intermediate result) of the first layer (e.g., the sensing expert layer). Additionally, the sensing information may be used as input of the subsequent layer (e.g., the prediction expert layer). Likewise, in the AI model 550 shown in FIG. 5B, the output of the sensing expert layer may be used as input of the prediction expert layer.

Information obtained inside the AI model may be the output (e.g., an intermediate output) generated by the previous layer. For example, as shown in FIGS. 5A and 5B, the input of the prediction expert layer may be the output of the sensing expert layer, which is the previous layer of the prediction expert layer. Further, the input of the planning expert layer may be the output of the prediction expert layer, which is the previous layer. In the AI model 500 shown in FIG. 5A, the output of the prediction expert layer may be prediction information as the output result of the layer and may also be used as input of the subsequent layer (e.g., the planning expert layer). The planning expert layer may be the terminal layer of the AI model 500. The output of the planning expert layer may correspond to planning information indicating an autonomous driving trajectory and/or operation of the electronic device. As described above, in each of the AI models 500 and 550 shown in FIGS. 5A and 5B, the output of the previous layer may be used as input of the subsequent layer, and the electronic device may obtain sensing information, prediction information, and planning information (e.g., the driving trajectory and driving operation) based on the output of the terminal layer (e.g., the planning expert layer) that is the final layer connected in series.

For reference, as described above, the AI model (e.g., the AI model 200 of FIG. 2A, the AI model 500 of FIG. 5A, and/or the AI model 550 of FIG. 5B) may include at least one of a first layer for sensing the current driving scenario, a second layer for predicting the subsequent state of the device or a nearby object, and a third layer for planning a control operation and/or a device movement path. In this case, each layer may perform a different task.

By way of example, driving scenarios sensed by the electronic device may include passing through a congested section, entering a green wave (e.g., sequential green lights) section, driving in the rain, driving at night, and the like.

By way of example, in autonomous driving scenarios, objects positioned near the electronic device may include other vehicles, pedestrians, and the like, and the predicted subsequent states of such objects may vary depending on the object type. For example, the subsequent state of another vehicle may include braking, and lane changing, and the subsequent state of a pedestrian may include road crossing and stopping.

By way of example, in autonomous driving scenarios, planned control operations may include operations to be executed by the electronic device in the future and/or in response to the planned control operations being determined. For example, the planned control operations may include changing lanes, acceleration, deceleration, overtaking, and turning. In addition, the planned movement path of the electronic device may include a driving trajectory, such as the expected driving path represented in the form of coordinates.

Referring to FIG. 2B, according to one or more embodiments, a specific structure of an AI model 270 (e.g., the AI model 200 of FIG. 2A, the AI model 500 of FIG. 5A, and/or the AI model 550 of FIG. 5B) is shown. For example, the AI model 270 may be referred to as an MoSE. The AI model 270 may include layers for processing various tasks (e.g., the first layer 200_a, the second layer 200_b, and the third layer 200_c of FIG. 2A). For example, the AI model 270 may include a sensing expert layer 271, a prediction expert layer 272, and a planning expert layer 273. Each expert layer may include N sublayers. N may be a natural number greater than or equal to “1”. For example, the sensing expert layer 271 may be connected to other layers (e.g., the prediction expert layer 272 and/or the planning expert layer 273) sequentially or in parallel, and may include a plurality of networks (e.g., a general expert network and a plurality of skill expert networks). Likewise, the prediction expert layer 272 and the planning expert layer 273 may be connected to other layers in the same manner, and may each include a plurality of networks. Thus, the electronic device of one or more embodiments may improve the accuracy of sensed driving scenarios. The number of layers included in each task layer may be adjusted according to actual requirements, and is not limited.

Referring to FIG. 5A, the AI model 500 may include the additional output heads 510 and 520 introduced to some layers. In the autonomous driving process, the electronic device may obtain (e.g., determine and/or generate) outputs of the layers (e.g., the sensing expert layer, the prediction expert layer, and the planning expert layer), and store the outputs and/or provide the same to a user. For example, the electronic device may store the output of each layer in the form of a log, and may use the output for subsequent queries and data retrieval. Further, the electronic device may display the output of each layer through a screen of the electronic device. Accordingly, the electronic device of one or more embodiments may provide processed data generated in the autonomous driving process, such that the user may directly check the processed data, thereby enhancing user experience and such that the user may easily discover issues occurring during autonomous driving. For example, the outputs of the layers included in the AI model 500 may assist in implementing the interpretability of execution task information to be used for autonomous driving. For example, when presenting a reason for a predetermined task to the user, the electronic device may provide a detailed explanation for the planned task by combining sensed driving scenario information, predicted state information, and the like.

The electronic device according to one or more embodiments may implement an AI model with a layer structure of a task-level skill, and as shown in FIG. 2A, the operation of skill expert networks included in the layers (e.g., the first layer 200_a, the second layer 200_b, and the third layer 200_c) may correspond to how humans solve multi-step problems. Thus, the electronic device of one or more embodiments may effectively enhance the contextual understanding capabilities of AI models and improve the modal performance.

In an executable embodiment, at least one layer included in an AI model (e.g., the AI model 200 of FIG. 2A, the AI model 270 of FIG. 2B, the AI model 500 of FIG. 5A, and/or the AI model 550 of FIG. 5B) may include a third AI network (e.g., the general expert network 260 of FIG. 2A). The electronic device may process a plurality of first information based on the third AI network. For reference, the third AI network may also be referred to as a general expert network (e.g., the general expert network 260 of FIG. 2A).

For reference, compared to a skill expert network (e.g., the second AI networks 220 of FIG. 2A) for processing information about a predetermined driving scenario, the general expert network may process information about all driving scenarios.

For example, by using the general expert network, the electronic device may assist in processing data of various driving scenarios through the skill expert networks. In addition, when the electronic device trains the model using limited driving scenario data, by using the general expert network, the electronic device of one or more embodiments may supplement the performance instability of a skill expert network when processing predetermined driving scenario data.

Referring to FIG. 2A, the electronic device according to one or more embodiments may implement the AI model 200 by adding a general expert network 260 to each of the layers (e.g., the first to third layers 200_a to 200_c). The electronic device may process first information by directly inputting the first information into the general expert network 260, without assigning by a routing network (e.g., the first AI network 210 of FIG. 2A).

For example, a general expert network may include a driving general expert network (e.g., referred to as a first module or a first partial network) and/or a general knowledge expert network (e.g., referred to as a second module or a second partial network). The electronic device may train the driving general expert network (e.g., the first module or the first partial network) using knowledge related to autonomous driving (e.g., train the general expert network based on autonomous driving-related data). Thus, the electronic device of one or more embodiments may solve driving scenario problems that are not handled through some skill expert networks or limited training data. The electronic device may train the general knowledge expert network (e.g., the second module or the second partial network) using large-scale data. Thus, the electronic device of one or more embodiments may implement an LLM or a VLM, and the corresponding model may have a predetermined general knowledge capability.

The electronic device according to one or more embodiments may process a plurality of first information through the third AI network, based on the third AI network including a first module (or referred to as a first partial network; hereinafter, the first module) and/or a second module (or referred to as a second partial network; hereinafter, the second module).

The electronic device may process the plurality of first information through the first module or the second module.

For reference, the first information may include vision information and text information, and the electronic device may process the first information by directly inputting all vision information and all text information into the first module and/or the second module.

The electronic device according to one or more embodiments may determine execution task information to be used for autonomous driving, based on outputs obtained by processing the first information by at least one of the layers included in the AI model (e.g., the AI model 500 of FIG. 5A).

As shown in FIG. 5A, the electronic device may introduce the output heads 510 and 520 to some of the layers included in the AI model 500. The electronic device may output intermediate results from the output heads 510 and 520 of the respective layers. When determining the overall output of the AI model 500, the electronic device may comprehensively process the intermediate outputs from the respective layers.

For example, when a second AI network and a third AI network are included in one layer, the electronic device may use the respective outputs of the second AI network and the third AI network as the output of the layer. The electronic device may determine execution task information to be used for autonomous driving by combining the output of the layer with the output of another layer.

The electronic device according to one or more embodiments may determine the execution task information to be used for autonomous driving based on the output of a terminal layer based on the first information, the terminal layer corresponding to an output layer connected in series to at least one of the plurality of layers included in the AI model (e.g., the AI model 550 of FIG. 5B).

As shown in FIG. 5B, the electronic device may determine the overall output of the AI model 550 without introducing output heads to the respective layers included in the AI model 550. When determining the output based on the AI model 550, the electronic device may directly obtain and process the output of the terminal layer (e.g., the planning expert layer). In this case, the terminal layer may correspond to the output layer of the AI model 550, and may be the planning expert layer in FIG. 5B.

As shown in FIG. 2A, when determining the final output of the AI model 200, the electronic device according to one or more embodiments may predict the driving trajectory of the electronic device, generate a text corresponding to the driving scenario, and generate an interpretation corresponding to the driving scenario, based on combining the outputs of each general expert network 260 and the second AI networks 220 (e.g., the skill expert networks).

Hereinafter, an example of a method of training an AI model (e.g., referred to as an MoSE) by the electronic device according to one or more embodiments is described.

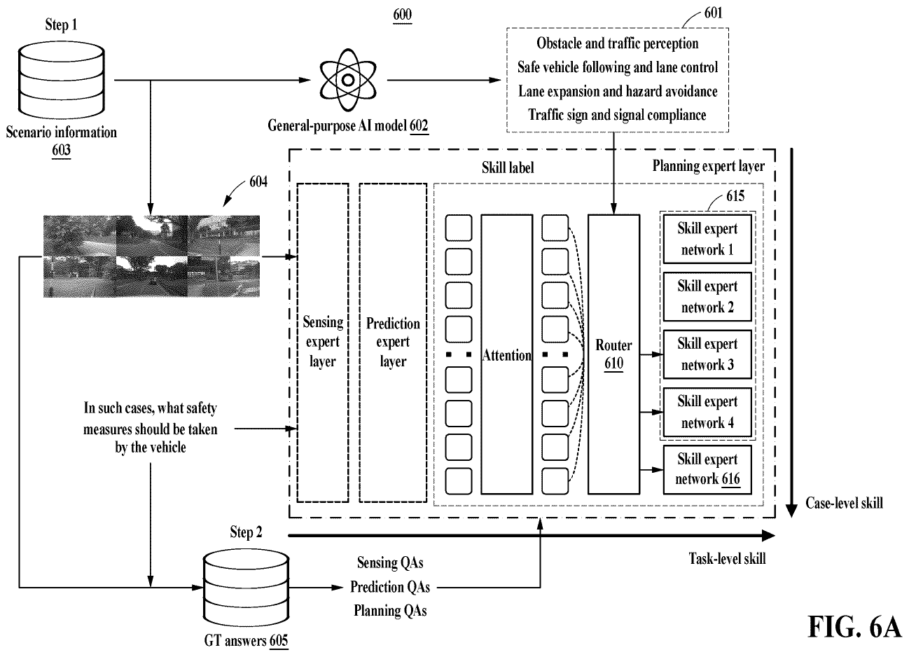

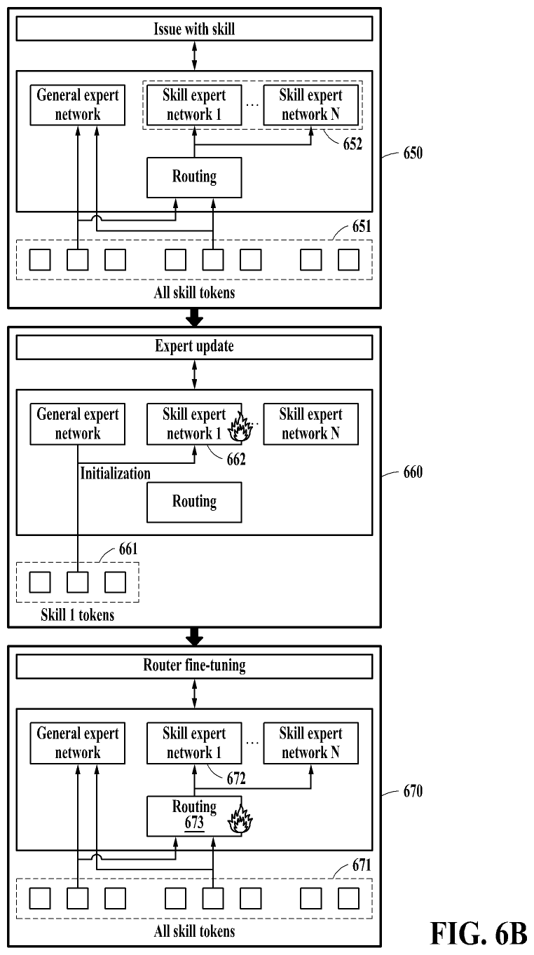

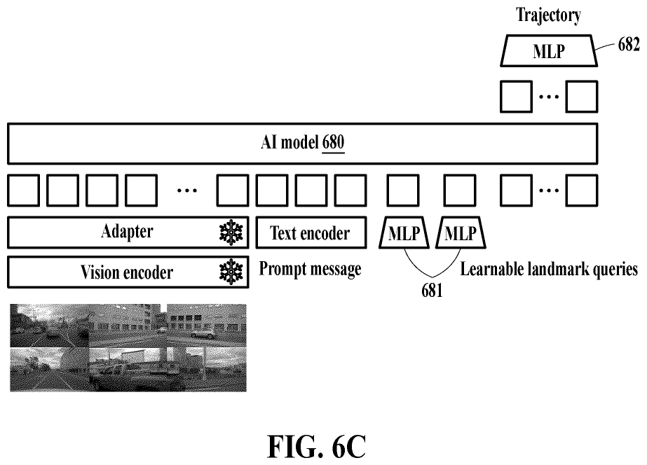

FIGS. 6A to 6C illustrate an example of a method of training an AI model according to one or more embodiments.

Referring to FIG. 6A, the electronic device according to one or more embodiments may enable an AI model 600 to mimic human learning and planning processes through case-level and task-level progressive skill learning. For example, case-level skill learning may be a method of training the AI model 600 for individual annotated cases or predetermined situations. For example, the electronic device may train the AI model 600 based on training data corresponding to specific driving situations such as “driving on a wet road”, “making a left turn at an intersection”, and “changing lanes on a highway”. For example, task-level skill learning may be a method of training the AI model 600 to develop predetermined driving skills or task execution capabilities. For example, the electronic device may train the AI model 600 to improve individual skills such as “vehicle detection”, “speed control”, and “obstacle avoidance” step by step. To construct the AI model 600, the electronic device may train a lightweight LLM to which vision-text alignment and instruction fine-tuning are applied. The electronic device may first pre-train a router 610 (e.g., the first AI network 210 of FIG. 2A) using a small amount of label data 601. The small amount of label data 601 may be data labeled with predetermined driving scenario information through a general-purpose AI model 602, but is not limited thereto. The electronic device may train the proposed AI model 600 to focus on scenario-level classification rather than label-level classification. The electronic device may train the router 610 (e.g., the first AI network 210 of FIG. 2A) based on features describing an input driving scenario. The router 610 may select and activate various skill expert networks 615 (e.g., the second AI networks 220 of FIG. 2A) corresponding to the features. In response to training the router 610, the electronic device may train MoSE networks (e.g., the skill expert networks 615 and a general expert network 616) for predetermined fields using a hierarchical skill learning strategy. The electronic device may maintain the general expert network 616 to be always activated, and capture global information using the general expert network 616 and enhance the robustness of the AI model 600. The AI model 600 may ensure not only that the skill expert networks 616 learns various skills corresponding to various driving scenarios, but also that the skill expert networks 615 learns various skills corresponding to various inference steps.

For reference, the router of the AI model included in the typical embodiment may automatically select an activation expert for each label. A router that is well trained by the training method of the typical embodiment often tends to focus on classifying different domains or patterns, which may not be sufficient for a predetermined task (e.g., autonomous driving). Further, the AI model included in the typical embodiment may be trained relying on large-scale data. In this case, the diversity of data plays an important role. However, in some domains, the cost of data labeling may be extremely high because ensuring high quality typically requires human resources. Further, the data distribution may be relatively narrow in some domains. For example, the data distribution range in domains corresponding to autonomous driving images or videos may be narrower than the data distribution range in Internet-scale data domains. Accordingly, issues related to autonomous driving images and videos may also have predetermined patterns. These two factors may introduce additional challenges to the method of training an AI model according to the typical embodiment, and carefully configured architectures and learning strategies are required to compensate for issues related to the scale and diversity of data. A human driver may obtain a driver's license by taking various tests for different subjects. These tests may focus on different driving skills (e.g., driving, parking, deceleration, etc.) to prepare for various driving scenarios. However, such logic may not be reflected in the AI model training process according to the typical embodiment. The electronic device according to one or more embodiments may train the AI model 600 through case-level progressive skill learning. The electronic device may train the AI model 600 to better understand driving scenarios and input text such that the router 610 may more accurately select an expert network based on the overall driving scenario. Accordingly, to train the AI model 600 to mimic the progressive skill learning process of a human driver, the electronic device according to one or more embodiments may include a multi-modal scenario routing mechanism, an example of which is described with reference to the first AI network 290 of FIG. 2B.

Referring to the first AI network 290 of FIG. 2B (e.g., the first AI network 210 of FIG. 2A), the electronic device may package input vision tokens 291 and text tokens 292 into a plurality of multi-modal groups (e.g., group 1 293 and group 2 294). For example, the electronic device may package the vision tokens 291 and the text tokens 292 into the multi-modal groups by pairing. For example, the electronic device may package a vision token V1 and a text token T1 into a single multi-modal group 1, and package a vision token V2 and a text token T2 into a single multi-modal group 2. In the same manner, the electronic device may package a vision token Vn and a text token Tn into a single multi-modal group N. Here, N may be an integer greater than or equal to “2”. For example, the electronic device may package a vision token Vn corresponding to an image corresponding to a predetermined road situation and a text token Tn corresponding to text information describing the situation into a single multi-modal group. As another example, the electronic device may package the vision tokens 291 and the text tokens 292 through complex packaging rules. For example, the electronic device may package one vision token with a plurality of text tokens 292, or conversely, a plurality of vision tokens 291 with one text token. For example, when a vision token V1 corresponds to a lane changing image, the electronic device may package the vision token V1 with a text token T1 corresponding to a traffic signal description and a text token T2 corresponding to driver behavior data into a single multi-modal group. However, this is merely an example, and the method of packing different tokens (e.g., the tokens 291 and 292) by the electronic device is not limited thereto.

Groups 293 and 294 may include at least one of the vision tokens 291 and at least one of the text tokens 292, and the electronic device of one or more embodiments may provide the groups 293 and 294 including multi-modal information to the first AI network 290, such that the first AI network 290 may better understand (e.g., more accurately determine one or more skill expert networks based on) the current driving scenario. The electronic device of one or more embodiments may package the tokens 291 and 292 having different modalities, thereby reducing the quantity of data to be input into the first AI network 290 from N×N, corresponding to the total number of existing tokens 291 and 292, to the number of groups 293 and 294.

Referring to FIG. 6A, the electronic device according to one or more embodiments may pre-train the router 610 using driving skill labels, such that the router 610 (e.g., the first AI network 210 of FIG. 2A) may focus on different driving scenarios. For example, the electronic device may construct training data based on nuScenes (a large-scale dataset for autonomous driving) and the DriveLM dataset. For example, the training data may include scenario information data 603 including the description of the current driving scenario and the state of the vehicle, image data 604 including front-view images, and ground truth (GT) data 605 labeled with expected driving trajectories and driving skills. The driving skills included in the GT data 605 may not be mutually exclusive and may include some redundancy and priority. For example, one driving scenario may simultaneously need both a skill 1 and a skill 2, and labels corresponding thereto may indicate safe vehicle following and speed control.

In response to the electronic device pre-training the router (e.g., the first AI network 210 of FIG. 2A), each of the respective skill expert networks (e.g., the second AI networks 220 of FIG. 2A) may focus on a respective different predetermined field. For example, the skill expert networks of FIG. 6A may focus on different driving skills, respectively.

The electronic device according to one or more embodiments may train the second AI networks (e.g., the second AI networks 220 of FIG. 2A), based on the pre-trained first AI network (e.g., the first AI network 210 of FIG. 2A, the first AI network 290 of FIG. 2B, and/or the router 610 of FIG. 6A).

Referring to FIG. 6A, the electronic device according to one or more embodiments may pre-train the router 610 (e.g., the first AI network 210 of FIG. 2A) included in one of the plurality of layers included in the AI model 600 and then apply network parameters of the pre-trained router 610 to routers included in the other layers (e.g., the sensing expert layer and the prediction expert layer). In response to pre-training the router 610 and applying network parameters, the electronic device may train the general expert network 616 and skill expert networks 615 based on the pre-trained router 610.

In training the second AI networks (e.g., the skill expert networks 615), the electronic device may control the first AI network (e.g., the router 610) to route training data associated with different driving skills, among autonomous driving-related data, to different second AI networks based on driving skills. For example, the electronic device may detect that a vehicle following skill is to be used in a driving scenario of entering a congested section, and enable the first AI network to identify sample data related to congested road section driving and vehicle following from driving-related data. In response to detecting that the vehicle following skill is to be used in the driving scenario, the electronic device may control the sample data to be assigned to a second AI network that realizes the vehicle following skill, thereby training the second AI networks.

According to one or more embodiments, the electronic device may train each AI network. The electronic device may train a third AI network (e.g., the general expert network 260 of FIG. 2A) based on the pre-trained first AI network.

For example, the electronic device may train a first module (or referred to as a first partial network) by routing the autonomous driving-related data to the first module based on the first AI network.

Further, the electronic device may pre-train a second module (or referred to as a second partial network) based on predetermined sample data and then, fix network parameters corresponding to the pre-trained second module while training the first module based on the first AI network.

For example, the electronic device may train the first module to process data of all scenarios. For example, the electronic device may train the first module by controlling the first AI network to route all sample data of the autonomous driving-related data to the first module. Further, the electronic device may control the second module to perform pre-training using preset sample data (e.g., a large volume of general data), before the second module is trained based on the first AI network. In response to performing the pre-training, in a subsequent training process based on the first AI network, the electronic device may set the network parameters of the second module, obtained through pre-training, to be fixed to prevent the loss of the general knowledge capability (i.e., prevent the networks parameters from being changed during the training process). Thus, the electronic device of one or more embodiments may prevent the loss of the general knowledge capability of the second module even in subsequent training and fine-tuning processes.

The electronic device may initialize the weights of the router 610 and train the entire AI model 600. The electronic device may control the respective skill expert networks 615 to focus on different driving skills by utilizing the pre-trained router 610. Considering that different skill expert networks 615 may focus on different driving skills in a driving scenario, the electronic device may additionally fine-tune the router 610 together with the skill expert networks 615. Further, the electronic device may control the skill expert networks 615 to process dynamic routing results using duplicated skill labels. In addition to performing case-level skill learning according to the instructions of the pre-trained router 610, the electronic device may integrate internal planning of the AI model 600 and human step-by-step planning. The electronic device of one or more embodiments may optimize the AI model 600 to enhance the consistency among multiple tasks through such multi-step planning and increase the inference performance between similar steps in complex QA. In addition, when performing sensing, prediction, and planning tasks for an autonomous driving task, the electronic device may consider issues that may arise from directly using the traditional QA approach as context. For example, the electronic device may consider cases where a small-scale AI model 600 experiences difficulties in processing long contexts or requires a long inference time in multi-step QA. Accordingly, the electronic device of one or more embodiments may perform multi-step training, thereby enhancing the stepwise inference capability of the AI model 600 without adding computational cost, thereby introducing a sensing-prediction-planning flow as an embedded mechanism. As shown in FIG. 6A, in response to training the AI model 600, the electronic device may transmit data to different layers and control the skill expert networks 615 of each respective layer may focus on different task-level skills. In this case, the electronic device may define and manage the sensing, prediction, and planning skills as task-level skills.

During the training process, the electronic device may divide given training data into three parts of sensing, prediction, and planning, and then assign the parts to the skill expert networks 615 included in the corresponding layers (e.g., the sensing expert layer nₚₑᵣₚ, the prediction expert layer n_{pred}, and the planning expert layer nₚₗₐₙ), respectively. Thus, the electronic device of one or more embodiments may control each of the skill expert networks 615 to acquire unique and predetermined expert knowledge. For example, the electronic device may train a first expert network included in a 0-th layer (e.g., the sensing expert layer) to focus on a sensing task related to skills for safely following other vehicles and controlling speed. Further, the electronic device may train the AI model 600 through QAs data (e.g., sensing QAs, prediction QAs, and planning QAs) post-processed using a standard LLM training loss function.

When the performance of any one of the plurality of second AI networks (e.g., the skill expert networks 615 of FIG. 6A) fails to satisfy a predetermined performance requirement, the electronic device according to one or more embodiments may additionally obtain data corresponding to driving skills associated with the corresponding second AI network. The electronic device may train the corresponding second AI network based on the additionally obtained data, thereby updating the parameters corresponding to the second AI network.

In addition, the electronic device may fix the network parameters corresponding to the plurality of second AI networks, obtain autonomous driving-related data, and train the first AI network (e.g., the router 610 of FIG. 6A). Thus, the electronic device of one or more embodiments may update the network parameters corresponding to the first AI network. For reference, the electronic device may update the network parameters by adjusting the weights and/or biases corresponding to the AI networks included in the AI model 600.

Referring to FIG. 6B, a method of fine-tuning a skill expert network corresponding to a driving skill or scenario when an issue occurs in the driving skill or scenario (e.g., when a vehicle following distance is uncontrollable due to an issue in the vehicle following skill in an autonomous driving scenario), in response to the electronic device according to one or more embodiments training the skill expert network 652 based on the autonomous driving-related data (e.g., all skill tokens 651) is shown.

For example, in operation 650, the electronic device according to one or more embodiments may train a general expert network and each skill expert network based on the autonomous driving-related data (e.g., all skill tokens). In response to the training, the electronic device may identify an issue with a predetermined skill. For example, FIG. 6B shows a case where the electronic device identifies an issue with a driving skill 1.

In operation 660, the electronic device according to one or more embodiments may obtain tokens 661 corresponding to the driving skill 1. The electronic device may separately train the skill network 1 662 to be used to implement the driving skill 1 based on the tokens 661. Thus, the electronic device of one or more embodiments may update the network parameters of the skill expert network 1 662 and improve the performance of the AI model corresponding to the driving skill.

In operation 670, the electronic device according to one or more embodiments may implement an updated skill expert network 1 672 and combine all skill tokens 671 with the updated skill expert network 1 672, thereby updating a routing network 673 (e.g., the first AI network 210 of FIG. 2A, the first AI network 290 of FIG. 2B, and the router 610 of FIG. 6A). For example, the electronic device may fine-tune the routing network 673. Thus, the electronic device of one or more embodiments may implement an update process on a portion of the networks, rather than updating all layers and networks included in the AI model at once. In fine-tuning the routing network 673, the electronic device may first fix the network parameters of the updated second AI network (e.g., the updated skill expert network 1 672) and then train the AI model based on the autonomous driving-related data. For example, the electronic device may restrict the parameter update to the routing network 673 in operation 670.

In summary, the electronic device according to one or more embodiments may update the AI model only for a predetermined driving skill through the update process on a portion of the AI networks included in the AI model, thereby quickly updating the AI model for the driving skill that lacks the designated performance.

Referring to FIG. 6C, the electronic device may train an AI model 680. For example, the electronic device may consider that it is not easy to directly output a fine-tuned trajectory from a small-scale VLM. The electronic device may perform trajectory prediction using learnable queries and a trajectory prediction head to perform low-level planning more effectively. For example, the electronic device may extract features to be used for trajectory prediction from input data, convert the features into learnable queries, and train the AI model 680 to generate optimal trajectories. The AI model 680 may include MoSE-LLaVA, which is a vision- and text-based MoSE. In response to the AI model 680 being trained, the electronic device may perform trajectory training while the architecture of the AI model 680 is fixed. During this process, the electronic device may input additional to be used for trajectory prediction based on the pre-trained AI model 680, and train the AI model 680 to generate more precise driving trajectories through the trajectory prediction head. Thus, the electronic device of one or more embodiments may perform more efficient trajectory planning while compensating for the limitations of small-scale VLMs.

As shown in FIG. 6C, the electronic device may generate expected landmarks using learnable queries and predict a trajectory based on the landmarks. For example, the electronic device may determine differences between landmarks using a multi-layer perception (MLP) 681 based on the output features. For example, the electronic device may integrate state information of a vehicle and landmark information of a road environment through the MLP 681 and provide the driving-related information to the AI model 680. Through this, the electronic device may control the AI model 680 to learn important features (e.g., lanes, traffic lights, signs, buildings, etc.) on the road for autonomous driving. The electronic device may perform trajectory prediction by inputting the output from the AI model 680 into an MLP 682. For example, the electronic device may generate the final trajectory by accumulating the output of the AI model 680 through the MLP 682.

The electronic device according to one or more embodiments may pre-train a multi-modal routing network (e.g., the first AI network 210 of FIG. 2A) included in an AI model (e.g., the AI models 200, 500, 550, and 680 of FIGS. 2A, 5A, 5B, and 6C) so as to train the AI model more effectively while ensuring that each of the plurality of AI networks constituting layers included in the AI model may focus on different driving scenarios. The electronic device may define different driving skills during the pre-training process and train the router, thereby selecting corresponding skill expert networks (e.g., the second AI networks 220 of FIG. 2A) according to the driving scenario. To mimic the human multi-step inference process, the electronic device may train the AI model in a progressive skill training manner. For example, the electronic device may divide a dataset and train experts of different layers of the model separately, thereby implementing a multi-step inference process without relying on additional inference.

The electronic device according to one or more embodiments may configure a lightweight LLM adaptive to the model size requirements for autonomous driving tasks and introduce an improved MoE (e.g., an improved MoSE), thereby enhancing the performance of the AI model with fewer parameters. The electronic device may apply a skill-level multi-modal packaging strategy to input data. In addition, the electronic device may introduce layer experts into the AI model having a transformer architecture (e.g., a neural network model based on an attention mechanism), thereby configuring the model to align with human multi-step problem-solving skills. Based on a multi-stage training strategy, the electronic device may perform predetermined skill training and fine-tuning for downstream tasks by individually training the networks corresponding to different skills. Furthermore, the electronic device may promptly update the AI model for a predetermined skill lacking the designated performance, thereby updating a layer or network related to the predetermined skill.

Hereinafter, an example of the autonomous driving performance of the electronic device according to one or more embodiments is described based on FIG. 7.

In FIG. 7, the results of autonomous driving performed by a typical embodiment 701 and an electronic device 700 are compared. Referring to FIG. 7, the electronic device 700 may define three predetermined autonomous driving skills, in an autonomous driving situation. For example, the electronic device 700 may define flat road driving, responding to traffic signals, and lane changing as autonomous driving skills. The typical embodiment 701 proposes a stop decision and the reason based on an input image 710. In contrast, the electronic device 700 may solve QA problems of autonomous driving more effectively based on an MoSE. For example, the electronic device may analyze the current road environment based on the input image 710 and determine more precisely whether the vehicle can proceed. In the typical embodiment 701, the focus is on simply detecting the road situation and making a stop decision, without considering detailed context. That is, rather than comprehensively analyzing the movements and predicted paths of other vehicles, a stop decision is made conservatively. However, the electronic device 700 may determine that the vehicle can continue proceeding by comprehensively considering the smooth road, movement of the vehicle within the lane, and predicted paths of nearby vehicles in the input image 710. For example, the electronic device may analyze whether there is an obstacle in the current lane and the vehicle can safely proceed within the lane, and then derive a conclusion that “the vehicle can keep proceeding without the need to stop”.

The electronic device 700 according to one or more embodiments may implement an MoSE that mimics the learning and inference processes of a human driver and matches a pre-trained VLM more to a downstream task (e.g., autonomous driving with limited data). In particular, the electronic device 700 may apply a training strategy that introduces case-level skill learning and utilize a multi-modal scenario router to learn and identify driving skills required in various driving scenarios. The electronic device 700 may apply a hierarchical training strategy such that expert networks may be configured to think step by step, for more matching between a human inference process and multi-step planning of an end-to-end driving model in the driving process. The electronic device 700 may efficiently perform a driving decision without the additional cost of computation by integrating auxiliary tasks into a single task process. Based on this, the electronic device 700 may execute single-round QA without context and make faster and more accurate autonomous driving decisions.

FIG. 8 illustrates an example of a schematic structure of an electronic device according to one or more embodiments.

As shown in FIG. 8, an electronic device 8000 may include a processor 8001 (e.g., one or more processors), a memory 8003 (e.g., one or more memories), and a sensor 8005 (e.g., one or more sensors). The processor 8001, the memory 8003, and the sensor 8005 may be connected via a bus 8002. For example, the electronic device 8000 may further include a transceiver 8004. The transceiver 8004 may be used to exchange data, such as transmit and/or receive data between the electronic device 8000 and another electronic device. The transceiver 8004 is not limited to a single transceiver and is not limited to the structure of the electronic device 8000 shown in FIG. 8. The electronic device 8000 may be a first network node, a second network node, and/or a third network node in a system including a plurality of electronic devices. In an example, the electronic device 8000 may be, or be included in, a vehicle (e.g., a vehicle configured to perform autonomous driving).

The processor 8001 may be a central processing unit (CPU), a general-purpose processor, a digital signal processor (DSP), an application-specific integrated circuit (ASIC), a field-programmable gate array (FPGA), and/or another programmable logic device, transistor logic device, hardware component, and/or any combination thereof. The processor 8001 may be implemented or executed by an exemplary logic block, module, and/or circuit. The processor 8001 may be a combination that realizes computing functions, such as a combination of one or more microprocessors, a combination of a DSP and a microprocessor, and the like.

The bus 8002 may include a path for transmitting information between the components described above. The bus 8002 may be a peripheral component interconnect (PCI) bus or an extended industry standard architecture (EISA) bus. The bus 8002 may be classified into an address bus, a data bus, a control bus, and the like. For convenience of illustration, FIG. 8 shows only a single bold line, but the bus 8002 is not limited thereto.

The memory 8003 may be a read-only memory (ROM) or another type of static storage device for storing static information and instructions, and/or a random-access memory (RAM) or another type of dynamic storage device for storing information and instructions. Further, the memory 8003 may include an electrically erasable programmable read-only memory (EEPROM), a compact disk read-only memory (CD-ROM) or other optical disk storage, optical disk storage (including compact optical disks, laser disks, optical disks, digital versatile disks, Blu-ray disks, etc.), disk storage media, other magnetic storage devices, and/or any other medium capable of storing or carrying computer programs and readable by a computer.

The memory 8003 may store computer programs for executing the methods described above with reference to FIGS. 1 to 7. The computer programs stored in the memory 8003 may be controlled by the processor 8001. For example, the memory 8003 may be or include a non-transitory computer-readable storage medium storing instructions that, when executed by the processor 8001, configure the processor 8001 to perform any one, any combination, or all of the operations and/or methods disclosed herein with reference to FIGS. 1-8.

The sensor 8005 may be or include one or more cameras, one or more LiDAR sensors, one or more radar sensors, one or more inertial measurement units (IMUs), one or more accelerometers, one or more speed sensors, and/or one or more GPS devices, as non-limiting examples. The sensor 8005 may generate (e.g., sense) any or all of the first information described herein with reference to FIGS. 1-8.

The modules, vision encoders, text encoders, electronic devices, processors, memories, transceivers, sensors, module 240, vision encoder 202, text encoder 205, electronic device 8000, processor 8001, memory 8003, transceiver 8004, and sensor 8005 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
processing a plurality of first information related to autonomous driving based on an artificial intelligence (AI) model comprising a first AI network and a plurality of second AI networks associated with one or more driving skills; and
determining execution task information for autonomous driving, based on an output corresponding to the plurality of first information, generated by one or more second AI networks of the plurality of second AI networks,
wherein the processing comprises:
determining the one or more second AI networks associated with each of the plurality of first information based on the first AI network; and
processing the plurality of first information based on the one or more second AI networks.

2. The method of claim 1, wherein
each of the plurality of first information corresponds to a different modality, and
the determining of the one or more second AI networks comprises:
generating two or more sets of second information comprising information corresponding to different modalities, by performing multi-modal fusion for each of the plurality of first information; and
routing each of the two or more sets of second information to one or more associated second AI networks based on the first AI network.

3. The method of claim 2, wherein the AI model comprises either one or both of:
one or more layers comprising the first AI network and the second AI networks; and
two or more layers connected in series or in parallel.

4. The method of claim 3, wherein the AI model comprises any one or any combination of any two or more of:
a first layer configured to sense a driving scenario of the electronic device;
a second layer configured to predict a next state of the electronic device or an object positioned in the vicinity of the electronic device; and
a third layer configured to plan either one or both of a control operation corresponding to the electronic device and a movement path corresponding to the electronic device.

5. The method of claim 3, further comprising:
generating an output of each of the layers; and
performing either one or both of storing the output in a memory and providing the output to a user of the electronic device.

6. The method of claim 3, wherein
the one or more layers further comprises a third AI network, and
further comprising processing the plurality of first information based on the third AI network.

7. The method of claim 6, wherein
the third AI network comprises a first partial network trained based on autonomous driving-related data and/or a second partial network trained based on predetermined sample data, and
the processing of the plurality of first information based on the third AI network comprises either one or both of:
processing the plurality of first information based on the first partial network; and
processing the plurality of first information based on the second partial network.

8. The method of claim 3, wherein the determining of the execution task information for autonomous driving comprises one of:
determining the execution task information for autonomous driving based on an output generated by processing the first information at the one or more layers; and
determining the execution task information for autonomous driving based on an output of a terminal layer based on the first information, the terminal layer corresponding to an output layer connected to the one or more layers in series.

9. The method of claim 2, further comprising:
training the second AI networks based on the first AI network that is pre-trained,
wherein the training of the second AI networks comprises routing training data associated with different driving skills, among different autonomous driving-related data corresponding to driving skills, to different second AI networks among the second AI networks, based on the first AI network.

10. The method of claim 7, further comprising:
training the third AI network based on the first AI network that is pre-trained,
wherein the training of the third AI network comprises:
training the first partial network by routing the autonomous driving-related data to the first partial network based on the first AI network;
pre-training the second partial network based on predetermined sample data; and
wherein the training of the first partial network is based on fixed network parameters corresponding to the pre-trained second partial network.

11. The method of claim 2, further comprising:
in response to performance of one of the plurality of second AI networks failing to meet predetermined performance requirements, updating parameters corresponding to the one second AI network by training the one second AI network based on data corresponding to a driving skill associated with the one second AI network;
fixing network parameters corresponding to the plurality of second AI networks; and
updating network parameters corresponding to the first AI network by training the first AI network based on autonomous driving-related data.

12. The method of claim 1, wherein
the plurality of first information comprises collected image information, input information received from a user of the electronic device, and/or information about a state of the electronic device, and
the execution task information for autonomous driving comprises any one or any combination of any two or more of:
information for determining a travel trajectory of the electronic device;
information for determining an execution operation of the electronic device;
information for interpreting the travel trajectory and/or the execution operation of the electronic device; and
information for answering a question from a user of the electronic device.

13. A processor-implemented method comprising:
generating two or more sets of second information corresponding to different modalities, by performing multi-modal fusion for each of a plurality of first information related to autonomous driving;
determining, using a first artificial intelligence (AI) network, one or more second AI networks from among a plurality of second AI networks associated with one or more driving skills, based on the generated two or more sets of second information; and
determining execution task information for autonomous driving by processing, using the determined one or more second AI networks, the two or more sets of second information.

14. An electronic device comprising:
one or more processors comprising processing circuitry;
memory comprising one or more storage media storing instructions that, when executed individually or collectively by the one or more processors, cause the electronic device to:
process a plurality of first information related to autonomous driving based on an artificial intelligence (AI) model comprising a first AI network and a plurality of second AI networks associated with one or more driving skills; and
determine execution task information for autonomous driving, based on an output corresponding to the plurality of first information, generated by one or more second AI networks of the plurality of second AI networks,
wherein, for the processing, the execution of the instructions causes the electronic device to:
determine the one or more second AI networks associated with each of the plurality of first information based on the first AI network; and
process the plurality of first information based on the one or more second AI networks.

15. The electronic device of claim 14, wherein
each of the plurality of first information corresponds to a different modality, and
for the determining of the one or more second AI networks, the execution of the instructions causes the electronic device to:
generate two or more sets of second information comprising information corresponding to different modalities, by performing multi-modal fusion for each of the plurality of first information; and
route each of the two or more sets of second information to one or more associated second AI networks based on the first AI network.

16. The electronic device of claim 15, wherein the AI model comprises either one or both of:
one or more layers comprising the first AI network and the second AI networks; and
two or more layers connected in series or in parallel.

17. The electronic device of claim 16, wherein the AI model comprises any one or any combination of any two or more of:
a first layer configured to sense a driving scenario of the electronic device;
a second layer configured to predict a next state of the electronic device or an object positioned in the vicinity of the electronic device; and
a third layer configured to plan either one or both of a control operation corresponding to the electronic device and a movement path corresponding to the electronic device.

18. The electronic device of claim 16, wherein the execution of the instructions causes the electronic device to:
generate an output of each of the layers; and
perform either one or both of storing the output in a memory and providing the output to a user of the electronic device.

19. The electronic device of claim 16, wherein
the one or more layers further comprises a third AI network, and
the execution of the instructions causes the electronic device to process the plurality of first information based on the third AI network.

20. The electronic device of claim 19, wherein
the third AI network comprises a first partial network trained based on autonomous driving-related data and/or a second partial network trained based on predetermined sample data, and
for the processing of the plurality of first information based on the third AI network, the execution of the instructions causes the electronic device to perform either one or both of:
processing the plurality of first information based on the first partial network; and
processing the plurality of first information based on the second partial network.
